(19) United States
(12) Patent Application Publication
(10) Pub. No.: US 2021/0315777 A1
(43) Pub. Date: Oct. 14, 2021

(54) CONNECTING DEVICE CONFIGURED TO CONNECT A CONTAINER TO A VIAL

(71) Applicant: LABORATOIRE AGUETTANT, LYON (FR)

(72) Inventors: Vincent GUYOT, MÜNCHEN (DE); Jeff TONNAR, LYON (FR)

(21) Appl. No.: 17/265,110

(22) PCT Filed: Jul. 24, 2019
(86) PCT No.: PCT/FR2019/051839

§ 371 Date: Feb. 1, 2021

(30) Foreign Application Priority Data
Aug. 1, 2018 (FR) 18/57211

(51) Int. Cl. A61J 1/20; A61J 1/14

(52) U.S. Cl. CPC A61J 1/2096; A61J 1/201; A61J 1/1412; A61J 1/2048; A61J 1/2082

(57) ABSTRACT

The connecting device includes a mounting portion configured to be mounted on a vial; a female coupling end piece intended to be coupled to the male coupling end piece of a container; a perforation element configured to perforate a perforable closure element equipping the vial; a protective cap which is removable and which at least partially delimits an inner chamber in which the female coupling end piece extends; at least one passage orifice opening into the inner chamber and intended for the passage of a sterilization gas; and a closing membrane located upstream of the at least one passage orifice relative to a direction of circulation of the sterilization gas through the connecting device, the closing membrane being porous and permeable to the sterilization gas.

### CROSS REFERENCE TO RELATED APPLICATIONS

This application is a National Stage of PCT Application No. PCT/FR2019/051839 filed on Jul. 24, 2019, which claims priority to French Patent Application No. 18/57211 filed on Aug. 1, 2018, the contents each of which are incorporated herein by reference thereto.

### BACKGROUND

The present invention concerns a connecting device configured to connect a container including a male coupling end piece to a vial including a vial body equipped with a neck sealingly closed with a perforable closure element.

A connecting device includes, in a known manner:
a mounting portion configured to be sealingly mounted on the vial body,
a female coupling end piece intended to be connected to the male coupling end piece of the container,
a perforation element which includes a connecting channel and which is configured to perforate the perforable closure element, the perforation element being movable between a rest position and a perforation position in which, when the connecting device is mounted on the vial body, the perforation element is able to perforate the perforable closure element and the connecting channel is able to fluidly connect the female coupling end piece to an inner volume of the vial body, and
a protective cap which is removable and which at least partially delimits an inner chamber in which at least the female coupling end piece partially extends, the protective cap at least partially covering and at least partially protecting the female coupling end piece.

Such a connecting device makes it possible to easily connect a container, such as a syringe, to a vial containing a product to be administered to a patient, and thus to quickly and easily collect a predetermined quantity of the contents of the vial.

Nonetheless, the sterilization of such a connecting device, and in particular of the female coupling end piece of the latter, can prove to be complex, or even impossible, due to the fact that the protective cap is generally sealingly fastened on the mounting portion. In addition, such a connecting device is generally sterilized after it has been mounted on the vial, which further complicates the step of sterilizing this assembly.

It is thus sometimes necessary to perform the step of assembling the connecting device and/or the step of fastening the latter on a vial in an asepticised manner, which considerably increases the manufacturing costs of a vial equipped with such a connecting device. In addition, an aseptic assembly of the connecting device on a vial is more risky from a microbiological quality perspective of the product contained in the vial, which can be detrimental to the patient.

### BRIEF SUMMARY

The present invention aims to remedy all or part of these drawbacks.

The technical problem underlying the invention therefore consists in providing a connecting device which is of simple and economical structure, while allowing optimal sterilization and at lower costs of the connecting device.

To this end, the present invention concerns a connecting device configured to connect a container including a male coupling end piece to a vial including a vial body equipped with a neck closed in a sealed manner, and preferably in a fluid-sealed manner, by a perforable closure element, the connecting device including:
a mounting portion configured to be mounted, in a sealed manner, and preferably in a fluid-sealed manner, on the vial body, and preferably on the neck,
a female coupling end piece intended to be coupled to the male coupling end piece of the container,
a perforation element which includes a connecting channel and which is configured to perforate the perforable closure element, the perforation element being movable between a rest position and a perforation position in which, when the connecting device is mounted on the vial body, the perforation element is able to perforate the perforable closure element and the connecting channel is able to fluidly connect the female coupling end piece to an inner volume of the vial body,
a protective cap which is removable and which at least partially delimits an inner chamber in which at least the female coupling end piece partially extends, the protective cap at least partially covering and at least partially protecting the female coupling end piece,

characterized in that the connecting device further includes:
at least one passage orifice opening into the inner chamber, and
a closing membrane at least partially covering the at least one passage orifice.

Such a configuration of the connecting device, and particularly the presence of the at least one passage orifice, makes it possible in particular to expose the female coupling end piece to a sterilization gas, such as water vapor or ethylene oxide, and thus effectively sterilize the connecting device.

The connecting device according to the present invention can, nonetheless, also be effectively sterilized by irradiation with gamma or beta rays.

In addition, the closing membrane prevents the penetration of impurity into the inner chamber via the at least one passage orifice and therefore guarantees the sterility of the female coupling end piece after the step of sterilizing the latter, including when storing and/or manipulating the connecting device.

It should be noted that the vial, to which the connecting device is intended to be connected, may be a vial commonly used to contain a product to be administered to a patient and be equipped with a perforable closing element commonly used for closing such a vial, or can be a specific vial equipped with a specific perforable closure element.

Advantageously, the connecting device is intended to be fastened in an Add-on manner to a commonly used or specific vial equipped with a commonly used or specific perforable closure element.

The connecting device may further have one or more of the following characteristics, considered alone or in combination.

According to an embodiment of the invention, the perforation element is movable between the rest position and the perforation position in a displacement direction substantially parallel to the longitudinal axis of the connecting device.

According to an embodiment of the invention, the at least one passage orifice is intended for the passage of a sterilization gas, and the closing membrane is porous and permeable to the sterilization gas. Such a configuration of the closing membrane allows the latter not to interfere with the circulation of a sterilization gas through the connecting device and therefore to the sterilization of the connecting device using such a gas.

According to an embodiment of the invention, the closing membrane is impermeable to microorganisms.

According to an embodiment of the invention, the closing membrane completely covers at least one passage orifice.

According to an embodiment of the invention, the closing membrane covers in a sealed manner, and preferably in a fluid-sealed manner, the at least one passage orifice.

According to an embodiment of the invention, the closing membrane is impermeable to fluid, and in particular to gas and/or liquid.

According to an embodiment of the invention, the closing membrane is located upstream of the at least one passage orifice with respect to a direction of circulation of the sterilization gas through the connecting device.

According to an embodiment of the invention, the closing membrane is made of Tyvek (registered trademark) or of a paper which is porous and permeable to a sterilization gas.

According to an embodiment of the invention, the at least one passage orifice is provided on the protective cap.

According to an embodiment of the invention, the closing membrane is fastened on the protective cap, for example by heat sealing.

According to an embodiment of the invention, the closing membrane is substantially planar.

According to an embodiment of the invention, the at least one passage orifice opens into the inner chamber facing an annular volume delimited at least partially by the protective cap and the female coupling end piece.

According to an embodiment of the invention, the protective device includes a plurality of passage orifices distributed, and for example regularly distributed, about a longitudinal axis of the connecting device.

According to an embodiment of the invention, the connecting device further includes a guide portion configured to guide, for example in translation, the perforation element during a displacement of the perforation element from the rest position towards the perforation position.

According to an embodiment of the invention, the perforation element extends inside the guide portion.

According to an embodiment of the invention, the perforation element is connected to the guide portion by at least one flexible connecting element.

According to an embodiment of the invention, the connecting device includes blocking means configured to block the perforation element in the rest position. Advantageously, the blocking means include a first blocking element provided on the perforation element, and a second blocking element provided on the guide portion and configured to cooperate with the first blocking element so as to block the perforation element in the rest position. The first blocking element may for example be an annular blocking rib and the second blocking element may for example be an annular blocking groove. Advantageously, the annular blocking rib is formed on an outer surface of the perforation element and extends about a longitudinal axis of the perforation element.

According to an embodiment of the invention, the guide portion includes a guide sleeve having a generally cylindrical shape.

According to an embodiment of the invention, the female coupling end piece is provided on a proximal end portion of the perforation element.

According to an embodiment of the invention, the female coupling end piece is provided on a proximal end portion of the guide portion.

According to an embodiment of the invention, the female coupling end piece and the perforation element are configured such that a coupling of a male coupling element on the female coupling element automatically causes a displacement of the perforation element from the rest position to the perforation position.

According to an embodiment of the invention, the protective cap is movably mounted relative to the mounting portion between a first protective position in which the protective cap is moved away from the mounting portion and a second protective position in which the protective cap is brought closer to the mounting portion, the protective cap and the perforation element being configured such that a displacement of the protective cap from the first protective position to the second protective position automatically causes a displacement of the perforation element from the rest position to the perforation position.

According to an embodiment of the invention, the mounting portion includes a hooking ring comprising hooking legs which are distributed angularly about a longitudinal axis of the connecting device and which are elastically deformable at least in one radial direction, the hooking legs being able to cooperate with an annular bead provided on the vial body so as to fasten the connecting device to the vial body.

According to an embodiment of the invention, the mounting portion further includes a locking ring slidably mounted relative to the hooking ring between a release position in which the hooking tabs are able to be elastically deformed according to a radial and outward direction, and a locking position in which the locking ring extends about hooking tabs and immobilizes the hooking tabs in a hooking position in which the hooking tabs cooperate with the annular bead provided on the vial body.

According to an embodiment of the invention, the locking ring and the hooking ring are sealingly mounted relative to each other.

According to an embodiment of the invention, the locking ring is coaxial with the hooking ring.

According to an embodiment of the invention, the guide portion is coaxial with the hooking ring.

According to an embodiment of the invention, the connecting device includes retaining means configured to retain the locking ring in the locking position.

According to an embodiment of the invention, the retaining means include a retaining element, such as an annular retaining rib or an annular retaining bead, provided on the locking ring and configured to cooperate, for example by snap-fitting, with the hooking ring when the locking ring is in the locking position. Advantageously, the retaining element is configured to cooperate with a lower end face of the hooking ring.

According to an embodiment of the invention, the retaining means include an inner thread provided on an inner surface of the locking ring, and an outer thread provided on an outer surface of the hooking ring and configured to cooperate with the inner thread provided on the locking ring.

According to an embodiment of the invention, the guide portion and the locking ring are made in one piece.

According to another embodiment of the invention, the guide portion and the hooking ring are made in one piece.

According to an embodiment of the invention, the protective cap is removably mounted, and preferably in a fluid-sealed manner, on the mounting portion. The protective cap can for example be removably mounted on the locking ring

According to another embodiment of the invention, the protective cap is removably mounted on the guide portion.

According to an embodiment of the invention, the protective cap is configured to be screwed on the mounting portion, and for example on the guide portion.

According to an embodiment of the invention, the protective cap includes a bottom wall and a lateral skirt extending from the bottom wall.

According to an embodiment of the invention, the at least one passage orifice is provided on the protective cap.

According to an embodiment of the invention, the connecting device further includes a tamper evident ring connected to the protective cap by a plurality of breakable elements.

According to an embodiment of the invention, the tamper evident ring is connected to the lateral skirt by the plurality of breakable elements.

According to an embodiment of the invention, the connecting device includes at least one retaining member, such as a retaining collar, the tamper evident ring being configured to cooperate with the at least one retaining member during the removal of the protective cap.

According to an embodiment of the invention, the at least one retaining member is provided on the mounting portion, and for example on the locking ring, or on the guide portion.

According to an embodiment of the invention, the lateral skirt comprises a first fastening element configured to cooperate, for example by screwing, clamping or snap-fitting, with a second fastening element provided on the mounting portion.

According to an embodiment of the invention, the female coupling end piece is a female Luer coupling end piece.

According to an embodiment of the invention, the container including the male coupling end piece is for example a syringe, such as an empty syringe or a pre-filled syringe, or else a vial or an administration bag.

According to an embodiment of the invention, the perforation element extends at least partially into the inner chamber.

According to an embodiment of the invention, the mounting portion is configured to exert pressure on the perforable closure element, and in particular to compress the perforable closure element, so as to produce a sealed mounting, and preferably in a fluid-sealed manner, of the mounting portion on the vial body.

According to an embodiment of the invention, the mounting portion includes a bearing rib configured to bear in a sealed manner, and preferably in a fluid-sealed manner, on the perforable closure element when the mounting portion is mounted on the vial body.

According to an embodiment of the invention, the perforation element is mounted in a sealed manner, and preferably in a fluid-sealed manner, relative to the guide portion.

According to an embodiment of the invention, the connecting device is provided with a system (filter, vent) facilitating the collection of the contents of the vial.

According to an embodiment of the invention, the connecting device includes a filtration chamber and the perforation element further includes a vent channel which is configured to fluidly connect the filtration chamber with the inner volume of the vial body when the perforation element is in the perforation position.

According to an embodiment of the invention, the connecting device includes at least one air filter which is disposed upstream of the vent channel. The at least one air filter is permeable to air and impermeable to microorganisms.

According to an embodiment of the invention, the at least one air filter is fastened to the perforation element and is configured to filter the air which comes from outside the connecting device and which is intended to flow through the vent channel.

According to an embodiment of the invention, the protective cap is configured such that the removal of the protective cap, for example by unscrewing or loosening or unclipping, automatically causes a displacement of the perforation element from the rest position to the perforation position.

According to an embodiment of the invention, the connecting device includes first guide means configured to guide the perforation element relative to the guide portion in a helical movement towards the mounting portion during a removal of the protective cap, and more particularly when unscrewing the protective cap.

According to an embodiment of the invention, the connecting device includes second guide means configured to guide the perforation element with respect to the protective cap in a longitudinal movement towards the mounting portion during a removal of the protective cap, and more particularly when unscrewing the protective cap.

According to an embodiment of the invention, the closing membrane is located outside the displacement path of the perforation element from the rest position to the perforation position. In other words, the perforation element is not configured to perforate the closing membrane.

According to an embodiment of the invention, the closing membrane is located at a distance from the distal end portion of the perforation element, and for example opposite the distal end portion of the perforation element, when the perforation element is in the rest position.

According to an embodiment of the invention, the closing membrane is configured to be located away from the vial body and the perforable closure element when the connecting device is mounted on the vial body.

The present invention further concerns an administration system comprising:
a vial including a vial body equipped with a neck, and a perforable closure element closing in a sealed manner, and preferably in a fluid-sealed manner, the neck of the vial body, and
a connecting device according to the invention, the connecting device being fastened to the vial body.

According to an embodiment of the invention, the neck of the vial body includes an annular bead.

According to an embodiment of the invention, the vial body contains a product to be administered to a patient, such as a medicinal solution, a solvent, or any other fluid which can be administered to a patient, or else a gas or a solid, such as a powder and in particular a lyophilized product. Such a product can for example be a component of a pharmaceutical preparation, such as for example its active principle.

According to an embodiment of the invention, the administration system further includes a container including a male coupling end piece intended to be coupled to the female coupling end piece of the connecting device.

According to an embodiment of the invention, the container is a pre-filled syringe, an empty syringe, a vial or an administration bag.

### BRIEF DESCRIPTION OF THE DRAWINGS

In any case, the invention will be clearly understood with the aid of the following description with reference to the appended schematic drawings representing, by way of non-limiting examples, several embodiments of this connecting device.

FIGS. 1 to 3 are longitudinal sectional views of a connecting device according to a first embodiment of the invention and in different positions of use.

FIGS. 4 and 5 are longitudinal sectional views of a connecting device according to a second embodiment of the invention and in different positions of use.

FIGS. 6 to 8 are longitudinal sectional views of a connecting device according to a third embodiment of the invention and in different positions of use.

FIGS. 9 to 11 are longitudinal sectional views of a connecting device according to a fourth embodiment of the invention and in different positions of use.

FIG. 12 is a perspective view of the perforation element of the connecting device of FIG. 9.

FIG. 13 is a top view of the perforation element of the FIG. 12.

### DETAILED DESCRIPTION

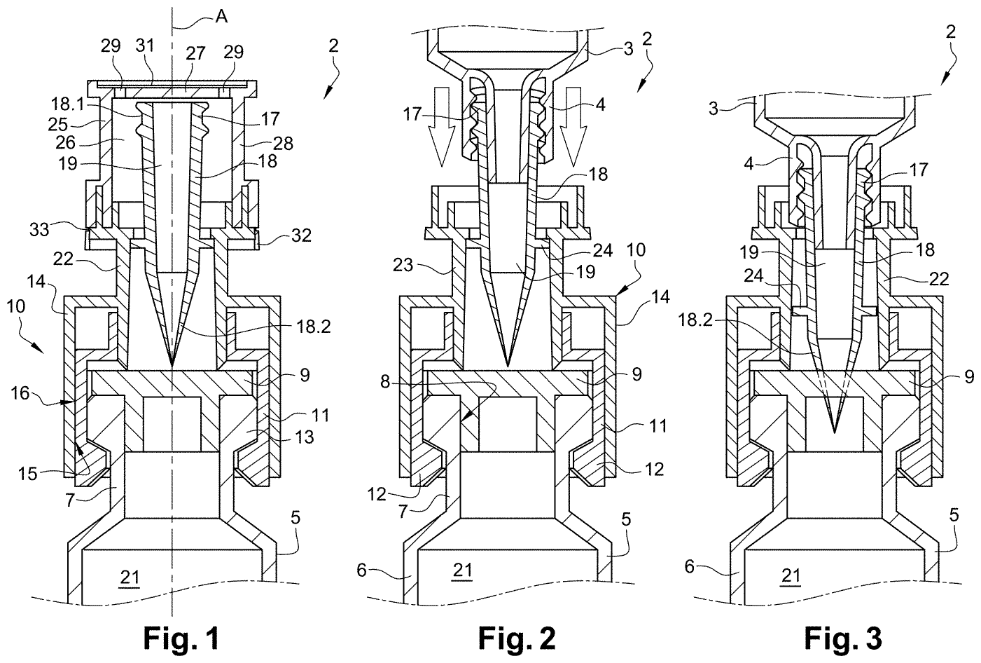

FIGS. 1 to 3 represent a connecting device 2 according to a first embodiment of the invention which is configured to connect a container 3, such as a syringe, including a male coupling end piece 4, for example of the Luer or Luer-Lock type, to a vial 5 including a vial body 6 equipped with a neck 7 whose opening 8 is closed in a fluid-sealed manner by a perforable closure element 9.

The connecting device 2 includes a mounting portion 10 configured to be mounted, in a fluid-sealed manner, on the vial body 6, and more particularly on the neck 7. The mounting portion 10 is more particularly configured to compress or clamp the perforable closure element 9 so as to achieve a fluid-sealed mounting of the mounting portion 10 on the vial body 6.

The mounting portion 10 includes a hooking ring 11 comprising hooking legs 12 which are distributed angularly about a longitudinal axis A of the connecting device 2 and which are elastically deformable in a radial direction. Each hooking leg 12 is more particularly elastically deformable between a deformed position in which said hooking leg 12 is deformed radially outwardly so as to allow a mounting of the hooking ring 11 on the neck 7 of the vial, and a hooking position in which said hooking leg 12 is able to cooperate with an annular bead 13 provided on the neck 7 of the vial 5 so as to fasten the connecting device 2 to the neck 7.

The mounting portion 10 further includes a locking ring 14 which is coaxial with the hooking ring 11 and which extends about the hooking ring 11. The locking ring 14 is slidably mounted relative to the hooking ring 11, in a sliding direction substantially parallel to the longitudinal axis A, between a release position (not represented in the figures) in which the locking ring 14 is axially offset relative to the hooking tabs 12 and the hooking tabs 12 are able to be elastically deformed in their deformed positions, and a locking position (visible in FIGS. 1 to 3) in which the locking ring 14 extends about the hooking tabs 12 and immobilizes the latter in their hooking positions.

Advantageously, the connecting device 2 includes retaining means configured to retain the locking ring 14 in the locking position. According to the embodiment represented in FIGS. 1 to 3, the retaining means may include for example an inner thread provided on an inner surface 15 of the locking ring 14, and an outer thread provided on an outer surface 16 of the hooking ring 11 and configured to cooperate with the inner thread provided on the locking ring 14.

The connecting device 2 also includes a female coupling end piece 17, for example a female Luer coupling end piece, intended to be coupled to the male coupling end piece 4 of the container 3.

The connecting device 2 further includes a perforation element 18 which includes a proximal end portion 18.1, a distal end portion 18.2 opposite the proximal end portion 18.1, and a connecting channel 19 extending over the entire length of the perforation element 18. Advantageously, the distal end portion 18.2 is pointed and is configured to perforate the perforable closure element 9. According to the embodiment represented in FIGS. 1 to 3, the female coupling end piece 17 is provided on the proximal end portion 18.2 of the perforation element 18.

The perforation element 18 is movable, for example in translation and in a displacement direction parallel to the longitudinal axis A of the connecting device 2, between a rest position (see FIGS. 1 and 2) in which the distal end portion 18.2 is recessed relative to the perforable closure element 9, and a perforation position (see FIG. 3) in which the distal end portion 18.2 is adapted to perforate the perforable closure element 9 and the connecting channel 19 is adapted to fluidly connect the female coupling end piece 17 to an inner volume 21 of the vial body 6.

The connecting device 2 further include a guide portion 22 configured to guide the perforation element 18 during a displacement of the perforation element 18 from the rest position to the perforation position. The guide portion 22 includes more particularly a guide sleeve 23 having a generally cylindrical shape and extending around the perforation element 18. Advantageously, the guide sleeve 23 is coaxial with the hooking ring 11. According to the embodiment represented in FIGS. 1 to 3, the guide portion 22 and the locking ring 14 are made in one piece, so that the guide portion 22 is an integral part of the mounting portion 10.

The connecting device 2 advantageously includes blocking means configured to block the perforation element 18 in the rest position. The blocking means may for example include an annular blocking rib 24 provided on an outer surface of the perforation element 18 and configured to cooperate with a blocking groove (not shown in the Figures) provided on an inner surface of the guide sleeve 23. The annular blocking rib 24 advantageously extends about a longitudinal axis of the perforation element 18.

The connecting device 2 also includes a protective cap 25 which is removable and which at least partially delimits an inner chamber 26 in which the female coupling end piece 17 at least partially extends and the perforation element 18. Thus, the protective cap 25 at least partially covers and at least partially protects the female coupling end piece 17 and the perforation element 18.

The protective cap 25 includes a bottom wall 27 and a lateral skirt 28 extending from the bottom wall. 27 and towards the mounting portion 10. According to the embodiment represented in FIGS. 1 to 3, the protective cap 25 is configured to be screwed onto the guide portion 22. The protective cap 25 could however also be configured to be clamped or clipped on the guide portion 22.

The connecting device 2 further includes a plurality of passage orifices 29 provided on the bottom wall 27 of the protective cap 25 and regularly distributed about the longitudinal axis A of the connecting device 2. Each passage orifice 29 opens into the inner chamber 26 and is intended for the passage of a sterilization gas, such as water vapor or ethylene oxide.

The connecting device 2 also includes a closing membrane 31 which is substantially planar and which is located upstream of the passage orifices 29 relative to a direction of circulation of the sterilization gas through the connecting device 2. The closing membrane 31 is porous and permeable to the sterilization gas. The closing membrane 31 is advantageously impermeable to microorganisms, and is for example made of Tyvek (registered trademark) or of porous paper and permeable to the sterilization gas.

The closing membrane 31 covers the bottom wall 27 of the protective cap 25 and in particular the passage orifices 29, and is fastened to the bottom wall 27 for example by heat sealing.

According to the first embodiment of the invention, the connecting device 2 further includes a tamper evident ring 32 connected to the lateral skirt 28 of the protective cap 25 by a plurality of breakable elements 33. Advantageously, the tamper evident ring 32 is configured to cooperate with a retaining element (not shown in the Figures), such as a retaining collar for example provided on the guide portion 22, when removing the protective cap 25, and this such that the tamper evident ring 32 is held on the connecting device 2 when removing the protective cap 25.

A method of collecting a product to be administered to a patient contained in a vial 5 equipped with the aforementioned connecting device 2 comprises the following steps:
removal of the protective cap 25 for example by unscrewing or loosening or unclipping,
connection of the male coupling end piece 4 of the container 3 to the female coupling end piece 17,
displacement of the perforation element 18 from the rest position to the perforation position by exerting pressure on the perforation element 18 using the container 3,
collection of a quantity of the product contained in a vial 5, for example by pulling on a piston rod equipping to the container 3 if the latter is a syringe.

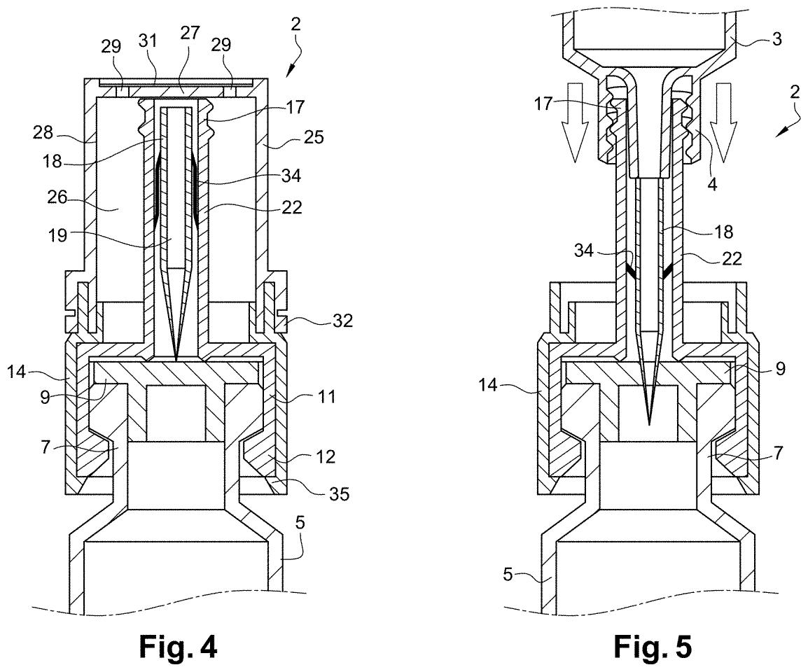

FIGS. 4 and 5 represent a connecting device 2 according to a second embodiment of the invention which differs from the first embodiment represented in FIGS. 1 to 3 essentially in that the female coupling end piece 17 is provided on a proximal end portion of the guide portion 22 and therefore distinct from the perforation element 18, and in that the perforation element 18 is connected to the guide portion 22 by at least one flexible connecting element 34.

According to the second embodiment of the invention, the female coupling end piece 17 and the perforation element 18 are configured such that the coupling of a male coupling end piece 4 to the female coupling end piece 17 automatically results in a displacement of the perforation element 18 from the rest position to the perforation position. Hence, it is not necessary for a user to exert a pressure on the perforation element 18, for example via the container 3, to displace it into the perforation position.

Furthermore, according to the second embodiment of the invention, the protective cap 25 is configured to be mounted, and for example screwed, clamped or clipped, on the locking ring 14, and the guide portion 22 and the hooking ring 11 are made in one piece.

In addition, according to the second embodiment of the invention, the retaining means, which are configured to retain the locking ring 14 in the locking position, include a retaining element 35, such as an annular retaining rib or an annular retaining bead, provided on the locking ring 14 and configured to cooperate, for example by snap-fitting, with the hooking ring 11 when the locking ring 14 is in the locking position. Advantageously, the retaining element 35 is configured to cooperate with a lower end face of the hooking ring 11.

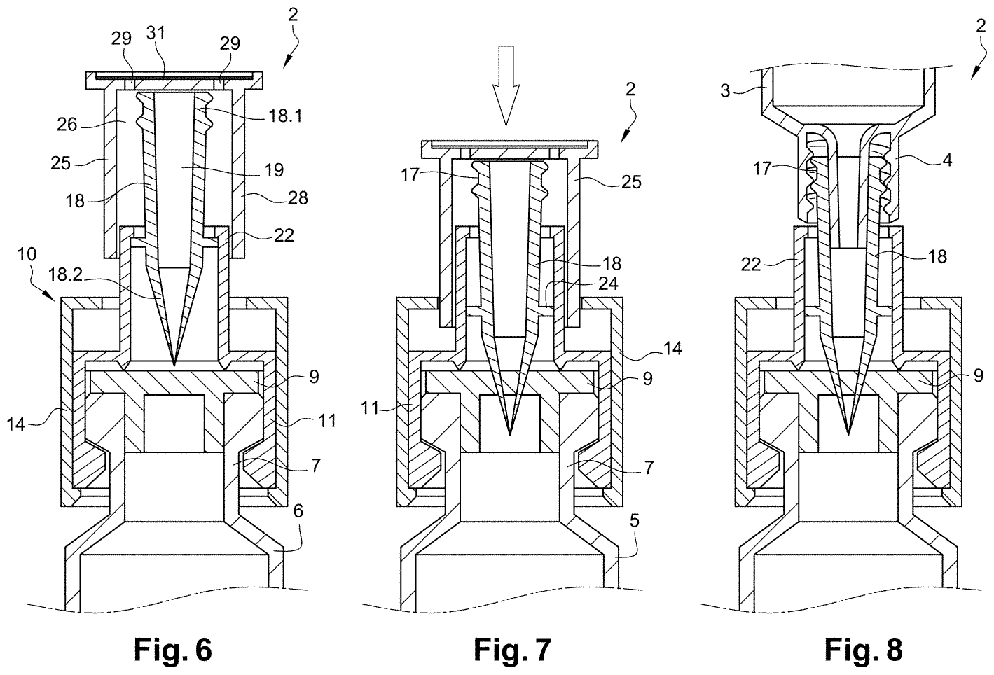

FIGS. 6 to 8 represent a connecting device 2 according to a third embodiment of the invention which differs from the first and second embodiments represented in FIGS. 1 to 5 essentially in that the protective cap 25 is movably mounted relative to mounting portion 10 between a first protective position (see FIG. 6) in which the protective cap 25 is moved away from the mounting portion 10 and a second protective position (see FIG. 7) in which the protective cap 25 is brought closer to the mounting portion 10, and in that the protective cap 25 and the perforation element 18 are configured such that a displacement of the protective cap 25 from the first protective position to the second protective position automatically causes a displacement of the perforation element 18 from the rest position to the perforation position. Such a configuration of the protective cap 25 allows ensuring a perforation of the perforable closure element 9 without risk of contamination of the female coupling end piece 17.

According to such an embodiment of the invention, the connecting device 2 advantageously includes guide means configured to guide the protective cap 25 relative to the mounting portion 10 during a displacement of the protective cap 25 from the first protective position to the second protective position. The guide means are for example configured to guide the protective cap 25 relative to the mounting portion 10 according to a helical movement or according to a longitudinal movement in the direction of the mounting portion 10 during a displacement of the protective cap 25 from the first protective position to the second protective position.

Advantageously, the guide means are also configured to guide the protective cap 25 relative to the mounting portion 10 during a displacement of the protective cap 25 from the second protective position to a retracted position of the protective cap 25. The guide means are for example configured to guide the protective cap 25 relative to the mounting portion 10 according to a helical movement away from the mounting portion 10 during a displacement of the protective cap 25 from the second protective position to the retracted position, or according to a first rotational movement and according to a second longitudinal movement away from the mounting portion 10 when displacing the protective cap 25 from the second protective position to the retracted position.

The guide means may for example include a guide pin provided on the protective cap 25 or the mounting portion 10, and a guide groove provided on the mounting portion 10 or the protective cap 25, the guide pin being slidably mounted in the guide groove. The guide groove may for example include a first helically wound groove portion, and a second groove portion extending in the extension of the first groove portion and substantially parallel to the longitudinal axis of the connecting device 2.

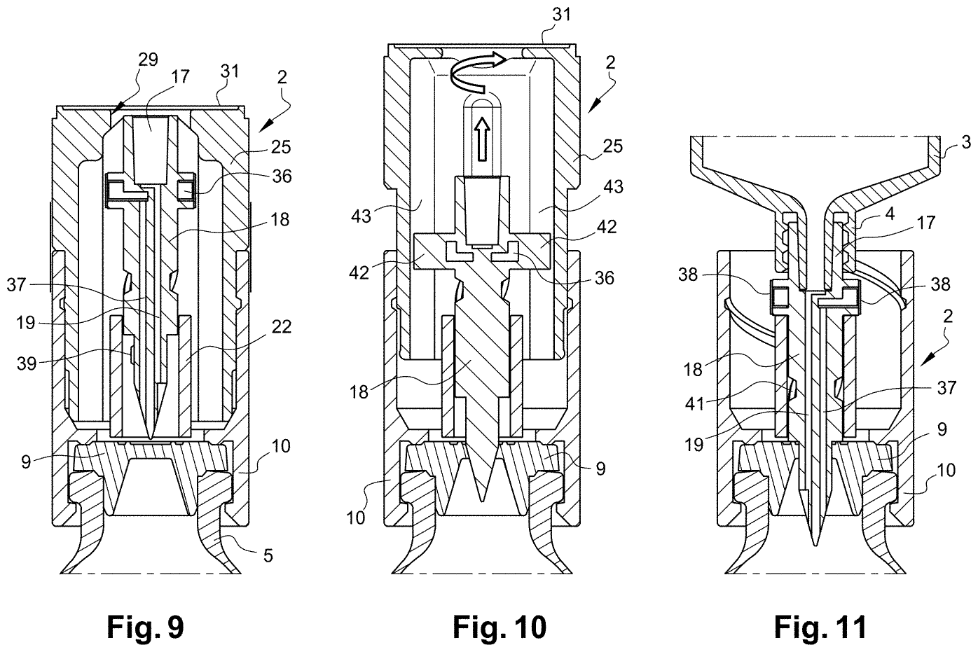

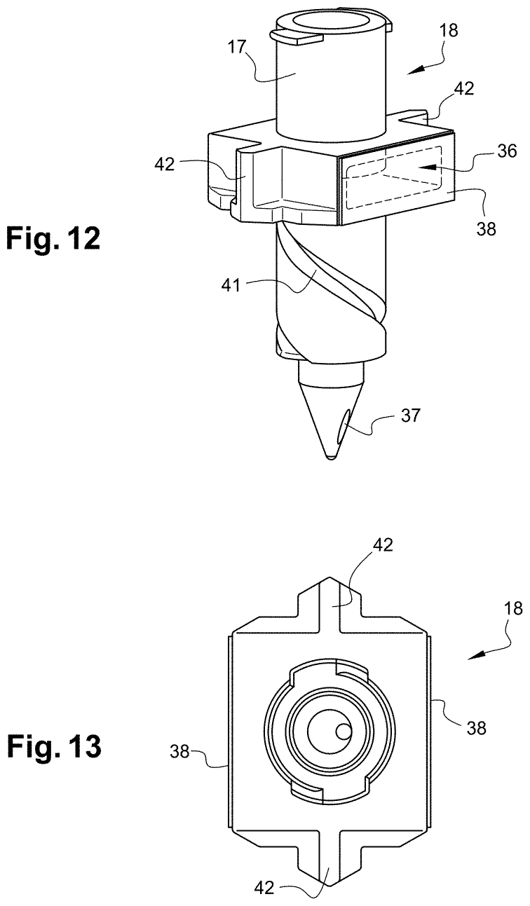

FIGS. 9 to 13 represent a connecting device 2 according to a fourth embodiment of the invention which differs from the first embodiment represented in FIGS. 1 to 3 essentially in that the connecting device 2 includes a filtration chamber 36 and in that the perforation element 18 further includes an vent channel 37 which is configured to fluidly connect the filtration chamber 36 with the inner volume 21 of the vial body when the perforation element 18 is in the perforation position, and in that the connecting device 2 includes at least one air filter 38 which is disposed upstream of the vent channel 37. The or each air filter 38 is permeable to air and impermeable to microorganisms. Advantageously, the or each air filter 38 is also impermeable to liquid at atmospheric pressure.

The or each air filter 38 is more particularly fastened to the perforation element 18 and is configured to filter the air which comes from outside the connecting device 2 and which is intended to flow through the vent channel 37. Advantageously, the vent channel the air 37 opens into the filtration chamber 36, and the or each air filter 38 at least partially forms one of the walls of the filtration chamber 36.

According to this fourth embodiment of the invention, the protective cap 25 is configured such that a removal of the protective cap 25, for example by unscrewing or loosening or unclipping, automatically causes a displacement of the perforation element 18 from the rest position to the perforation position.

To this end, the connecting device 2 may for example include first guide means configured to guide the perforation element 18 relative to the guide portion 22 according to a helical movement towards the mounting portion 10 during a removal of the protective cap 25, and more particularly when unscrewing the protective cap 25. The first guide means may for example include a guide pin 39 provided on the guide portion 22 or on the perforation element 18, and a helical guide groove 41 provided on the perforation element 18 or the guide portion 22, the guide pin 39 being slidably mounted in the helical guide groove 41.

The connecting device 2 may for example include second guide means configured to guide the perforation element 18 relative to the protective cap 25 according to a longitudinal movement towards the mounting portion 10 during a removal of the protective cap 25, and more particularly when unscrewing the protective cap 25. Advantageously, the second guide means include two guide protrusions 42 which are provided on the perforation element 18 and which are diametrically opposed, and two longitudinal guide grooves 43 which are provided on the protective cap 25, each guide protrusion 42 being slidably mounted in a respective longitudinal guide groove 43.

Thus, when the protective cap 25 is unscrewed, the perforation element 18 is automatically displaced into the perforation position in which the vent channel 37 fluidly connects the inner volume 21 of the vial body 10 with the filtration chamber 36. Therefore, when collecting a quantity of the product contained in the vial 5 via the connecting channel 19, air is sucked and filtered through the air filter(s) 38 and the filtered air flows through the vent channel 37 to the inner volume 21 of the vial body.

Of course, the invention is not limited to only embodiments of this connecting device, described above by way of example, it encompasses on the contrary all variants.

1. A connecting device configured to connect a container including a male coupling end piece to a vial including a vial body equipped with a neck sealingly closed by a perforable closure element, the connecting device including:
a mounting portion configured to be mounted on the vial body,
a female coupling end piece intended to be coupled to the male coupling end piece of the container,
a perforation element which includes a connecting channel and which is configured to perforate the perforable closure element, the perforation element being movable between a rest position and a perforation position in which, when the connecting device is mounted on the vial body, the perforation element is adapted to perforate the perforable closure element and the connecting channel is adapted to fluidly connect the female coupling end piece to an inner volume of the vial body,
a protective cap which is removable and which at least partially delimits an inner chamber in which the female coupling end piece at least partially extends, the protective cap at least partially covering and at least partially protecting the female coupling end piece,
wherein the connecting device further includes:
at least one passage orifice opening into the inner chamber, and
a closing membrane at least partially covering at least one passage orifice.

2. The connecting device according to claim 1, wherein the at least one passage orifice is intended for the passage of a sterilization gas, and the closing membrane is porous and permeable to the sterilization gas.

3. The connecting device according to claim 1, wherein the closing membrane is made of Tyvek or of a porous paper and permeable to a sterilization gas.

4. The connecting device according to claim 1, wherein the at least one passage orifice is provided on the protective cap.

5. The connecting device according to claim 1, wherein the closing membrane is fastened on the protective cap.

6. The connecting device according to claim 1, which further includes a guide portion configured to guide the perforation element during a displacement of the perforation element from the rest position to the perforation position.

7. The connecting device according to claim 1, wherein the female coupling end piece is provided on a proximal end portion of the perforation element.

8. The connecting device according to claim 6, wherein the female coupling end piece is provided on a proximal end portion of the guide portion.

9. The connecting device according to claim 1, wherein the female coupling end piece and the perforation element are configured such that a coupling of the male coupling end piece on the female coupling end piece causes a displacement of the perforation element from the rest position to the perforation position.

10. The connecting device according to claim 1, wherein the protective cap is movably mounted relative to the mounting portion between a first protective position in which the protective cap is moved away from the mounting portion and a second protective position in which the protective cap is moved closer to the mounting portion, the protective cap and the perforation element being configured such that a displacement of the protective cap from the first protective position to the second protective position causes a displacement of the perforation element from the rest position to the perforation position.

11. The connecting device according to claim 1, wherein the mounting portion includes a hooking ring comprising hooking tabs which are angularly distributed about a longitudinal axis of the connecting device and which are elastically deformable at least in a radial direction, the hooking legs being adapted to cooperate with an annular bead provided on the vial body so as to fasten the connecting device to the vial body.

12. The connecting device according to claim 11, wherein the mounting portion further includes a locking ring which is slidably mounted relative to the hooking ring between a release position in which the hooking tabs are adapted to be elastically deformed in a radial direction and outwardly, and a locking position in which the locking ring extends around the hooking tabs and immobilizes the hooking tabs in a hooking position in which the hooking tabs cooperate with the annular bead provided on the vial body.

13. The connecting device according to claim 1, which further includes a tamper evident ring connected to the protective cap by a plurality of breakable elements.

14. An administration system comprising:
a vial including a vial body equipped with a neck, and a perforable closure element sealingly closing the neck of the vial body, and
a connecting device, the connecting device configured to connect a container including a male coupling end piece to the vial, the connecting device including:
a mounting portion configured to be mounted on the vial body,
a female coupling end piece intended to be coupled to the male coupling end piece of the container,
a perforation element which includes a connecting channel and which is configured to perforate the perforable closure element, the perforation element being movable between a rest position and a perforation position in which, when the connecting device is mounted on the vial body, the perforation element is adapted to perforate the perforable closure element and the connecting channel is adapted to fluidly connect the female coupling end piece to an inner volume of the vial body,
a protective cap which is removable and which at least partially delimits an inner chamber in which the female coupling end piece at least partially extends, the protective cap at least partially covering and at least partially protecting the female coupling end piece,
wherein the connecting device further includes:
at least one passage orifice opening into the inner chamber, and
a closing membrane at least partially covering at least one passage orifice, and the connecting device being fastened to the vial body.

15. (canceled)

16. The administration system according to claim 14, wherein the container is one of: a pre-filled syringe, an empty syringe, a vial or an administration bag.

17. The connecting device according to claim 2, wherein the closing membrane is made of Tyvek or of a porous paper and permeable to a sterilization gas.

18. The connecting device according to claim 17, wherein the at least one passage orifice is provided on the protective cap.

19. The connecting device according to claim 18, wherein the closing membrane is fastened on the protective cap.

20. The connecting device according to claim 19, which further includes a guide portion configured to guide the perforation element during a displacement of the perforation element from the rest position to the perforation position.

21. The connecting device according to claim 20, wherein the female coupling end piece is provided on a proximal end portion of the perforation element.
